(19) United States
(12) Patent Application Publication
(10) Pub. No.: US 2010/0020997 A1
(43) Pub. Date: Jan. 28, 2010

(54) Hearing aid with transparent electrical hearing tube

(76) Inventor: Uwe Rass, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/503,883

(22) Filed: Jul. 16, 2009

(30) Foreign Application Priority Data
Jul. 25, 2008 (DE) 10 2008 034 714.0

(51) Int. Cl. H04R 25/00

(52) U.S. Cl. 381/322

(57) ABSTRACT

The invention relates to a hearing aid with a housing, a receiver disposed outside the housing and a transparent hearing tube to connect the receiver to the housing. At least one electrical line made of transparent, conductive polymer is provided in the hearing tube to connect the receiver electrically to an electronic signal processor disposed in the housing and at least one electrical insulator made of transparent, non-conductive polymer. A number of lines and insulators are advantageously disposed coaxially. The outer line is advantageously grounded. The impedance of the receiver and impedance of an amplifier output stage being part of the electronic signal processor and connected to the at least one line and the surface area of the line are advantageously tailored to one another so that the power transmission of the line is at a maximum. The hearing tube is completely transparent despite the electrical lines provided therein.

### CROSS REFERENCE TO RELATED APPLICATIONS

This application claims priority of German application No. 10 2008 034 714.0 filed Jul. 25, 2008, which is incorporated by reference herein in its entirety.

### FIELD OF THE INVENTION

The invention relates to a hearing aid with a housing, with a receiver disposed outside the housing and with a transparent hearing tube to connect the receiver to the housing, as well as a transparent hearing tube for a hearing aid.

### BACKGROUND OF THE INVENTION

Hearing aids with a receiver disposed outside the housing are generally what are known as behind-the-ear or BTE devices. As the name suggests, these are worn behind the ear, where they are accommodated in a manner that is relatively unobtrusive from a visual point of view. The housing of such BTE hearing aids is worn behind the ear, with functional components such as the electronic signal processor or the microphones disposed in the housing.

Essentially two variants of BTE hearing aids are commercially available. In one variant the receiver, which in hearing aids is the term used to designate the speaker for generating audible signals for the hearing aid wearer, is disposed in the housing. In the other variant the receiver is disposed outside the housing and is normally positioned in the auditory canal of the hearing aid wearer. Such devices are therefore referred to as RiC (Receiver-in-Canal) hearing aids.

With BTE hearing aids the hearing tube normally passes from the housing by way of the auricle to the auditory canal of the hearing aid wearer. At least the last section of the hearing tube, before it enters the auditory canal, is visible from the outside. With pure BTE hearing aids the hearing tube only serves to conduct audible signals, i.e. sound waves, from the housing to the auditory canal. It is therefore a simple plastic tube, which can be embodied easily in a transparent manner. It is important to the hearing aid wearer for both the housing and the hearing tube to be as visually unobtrusive as possible, so a transparent hearing tube is advantageous.

With RiC hearing aids the hearing tubes serves not to transmit acoustic signals from the housing to the auditory canal but to transmit electrical signals for actuating the receiver. First the receiver converts the electrical signals to acoustic audible signals for the hearing aid wearer. The electrical signals have to be conducted to the receiver by way of electrical lines. Metal conductors are generally used as the lines. Metal conductors are not transparent, so the hearing tube is not transparent either. To minimize visibility, very thin cables are therefore passed through an otherwise transparent hearing tube. Since at least three electrical lines are generally required, it is nevertheless impossible to avoid clear visibility.

Similar visibility problems occur when microphones for example are to be connected to the housing by way of a hearing tube in addition to the receiver or instead of the receiver. This is known for example in order to position a microphone in the auricle of the hearing aid wearer, thereby allowing the acoustic advantages of the auricle to be accessed. Other constellations with electrically conducting hearing tubes result for example with hearing aids which have contact with the concha or the helix of the auricle. Further electronic components are also possible, which have to be interfaced electrically, e.g. wireless or FM antennas, ambient sensors or visual or acoustic display facilities.

A microelectrode array is known from the publication EP 1 790 380 A1, which can comprise a polymer layer. The polymer can be transparent polydimethylsiloxane (PDMS). A transparent tube made from conductive polymer is known from the publication U.S. Pat. No. 5,713,864 A. The tube is intended to be used as a resistance heating element to heat liquids in a uniform manner.

### SUMMARY OF THE INVENTION

The object of the invention is to specify a hearing aid with a receiver disposed outside the hearing aid housing and having a hearing tube which is as visually unobtrusive as possible. The further object of the invention is to specify a hearing tube which is as visually unobtrusive as possible.

A basic concept of the invention is that of specifying a hearing aid, which comprises a housing, a receiver disposed outside the housing and a transparent hearing tube to connect the receiver to the housing, with at least one electrical line made of a transparent, conductive polymer being provided in the hearing tube to connect the receiver electrically to an electronic signal processor disposed in the housing, as well as at least one electrical insulator made of transparent, non-conductive polymer. The use of electrical lines and insulators made of transparent polymer advantageously results in a completely transparent and therefore barely visible hearing tube. The use of polymers also ensures adequate flexibility and elasticity of the hearing tube, as required to fit it to an auricle of a hearing aid wearer.

In one advantageous development a number of electrical lines made of transparent, conductive polymer are provided in the hearing tube, these being insulated by a number of electrical insulators made of transparent, non-conductive polymer. This also allows receivers or other electronic components with a number of poles to be interfaced electrically.

In a further advantageous development the lines and insulators are disposed coaxially. This coaxial arrangement allows lines with a particularly large surface area to be provided. The large surface areas can help to keep the electrical resistance of the lines at a sufficiently low level for use with hearing aids.

In a further advantageous development the outer line is grounded. This shields the inner signal-carrying lines, allowing a greater resistance to interference signals to be achieved.

In a further advantageous development the impedance of the receiver, the impedance of an amplifier output stage connected to the receiver and being part of the electronic signal processor and the surface area of the at least one line are tailored to one another in such a manner that the power transmission of the overall system is at a maximum. This allows effective actuation of the receiver to be achieved with minimum electrical power. In the tailoring process it is necessary to take account of the respective signal frequency, of which the complex-valued impedance of the receiver is a function. The impedance of the amplifier output stage can advantageously be tailored to the characteristics of the line in this process.

### BRIEF DESCRIPTION OF THE DRAWINGS

Further advantageous developments of the invention will emerge from the dependent claims and the description which follows of exemplary embodiments based on figures, in which:

FIG. 1 shows a hearing aid with a hearing tube and receiver

FIG. 2 shows a sectional image of a coaxially structured hearing tube

FIG. 3 shows a hearing tube with a strip-type structure.

### DETAILED DESCRIPTION OF THE INVENTION

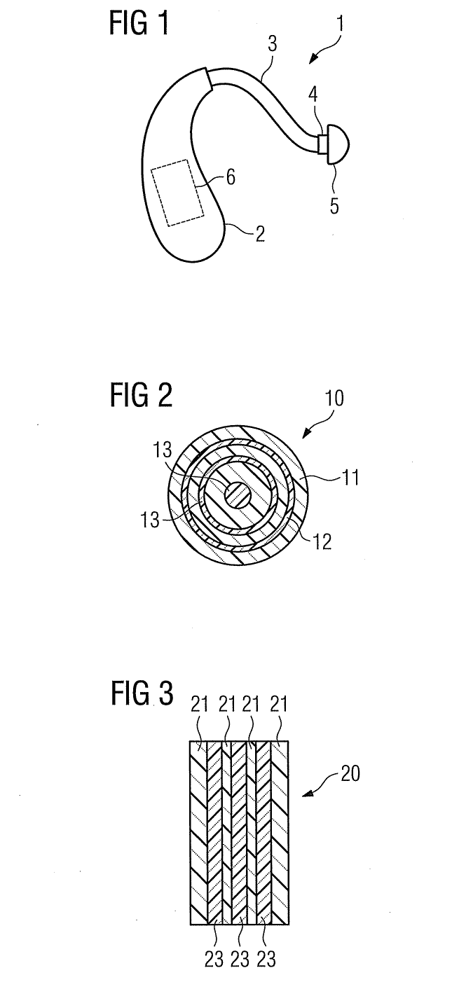

FIG. 1 shows a hearing aid 1 with a housing 2 and a receiver 4 that is disposed separately from the housing 2. The hearing aid 2 is embodied as a BTE hearing aid, the curved shape of the housing 2 and of the hearing tube 3 being provided to be passed round an auricle of a hearing aid wearer. The receiver 4 is intended to be inserted through the hearing tube 3 into an auditory canal of the hearing aid wearer, where it is positioned and fixed by what is known as a dome 5. The dome 5 is made from a soft, elastic material, e.g. a silicone.

An electronic signal processor 6 (shown with a broken line) is present in the housing of the hearing aid. The electronic signal processor 6 serves in particular to subject acoustic signals received from the hearing aid 1 by means of microphones (not shown in the figure) to a signal processing operation that is appropriate for the respective hearing aid wearer. An amplifier output stage (not shown), which is part of the electronic signal processor 6, generates electrical signals, which are converted by the receiver 4 to acoustic audible signals.

The electrical signals are alternating voltage signals based on a carrier frequency. They are conducted by electrical lines in the hearing tube 3 from the amplifier output stage of the electronic signal processor 6 to the receiver 4. In this process they experience a frequency-dependent line resistance and a frequency-dependent power damping. Power transmission is therefore a function of the frequency of the electrical signals, in particular of the carrier frequency. Generally power transmission is determined by the electrical characteristics, particular the surface area, of the lines in the hearing tube 3, the impedance of the receiver 4 and the impedance of the amplifier output stage.

Like the hearing tube 3 the electrical lines are made of transparent polymer. They are therefore barely visible.

FIG. 2 shows a schematic cross-section through a hearing tube 10. The hearing tube 10 comprises electrical lines 12, 13, which are disposed coaxially. They are insulated by insulators 11 disposed in a similarly coaxial fashion. The electrical lines 12, 13 and insulators 11 are made of transparent polymer so the entire hearing tube 10 is transparent. The coaxial structure means that the insulators 11 and lines 12, 13 appear as concentric circles in the sectional diagram.

The outer line 12 is advantageously grounded. Only the inner lines 13 conduct signals to the receiver. The outer ground line 12 sheathes the inner lines 13, thereby shielding them from electrical interference signals.

FIG. 3 shows a further variant of a hearing tube 20. The electrical insulators 21 alternate in strips with the electrical lines 23. Both the insulators 21 and the lines 23 are made of transparent polymer. The strip-type arrangement is particularly economical and simple to produce. It is also possible to provide the same size surface areas for each of the lines 23, thereby allowing identical electrical characteristics to be achieved.

A basic concept of the invention can be summarized as follows: The invention relates to a hearing aid with a housing, with a receiver disposed outside the housing and with a transparent hearing tube to connect the receiver to the housing. The hearing aid 1 comprises a housing 2, a receiver 4 disposed outside the housing 2 and a transparent hearing tube 3, 10, 20. According to the invention at least one electrical line 12, 13, 23 made of transparent, conductive polymer is provided in the hearing tube 3 to connect the receiver 4 electrically to an electronic signal processor 6 disposed in the housing 2 as well as at least one electrical insulator 11, 21 made of transparent, non-conductive polymer. A number of lines 12, 13 and insulators 11 are advantageously disposed coaxially. The outer line 12 is particularly advantageously grounded. The impedance of the receiver 4 and the surface area and/or electrical characteristics of the at least one line 12, 13, 23 are advantageously tailored to one another in such a manner that the power transmission of the overall system by way of the at least one line 12, 13, 23 is at a maximum. One advantage of the invention is that the hearing tube 3, 10, 20 is completely transparent despite the electrical lines 12, 13, 23 provided therein.

1.-10. (canceled)

11. A hearing aid, comprising:
a housing;
a receiver disposed outside the housing;
an electronic signal processor disposed in the housing; and
a transparent hearing tube that connects the receiver to the housing, the transparent hearing tube comprising:
an electrical line that is made of a transparent and conductive polymer and connects the receiver electrically to the electronic signal processor, and
an electrical insulator that is made of a transparent and non-conductive polymer and insulates the electrical line.

12. The hearing aid as claimed in claim 11, wherein the transparent hearing tube comprises a plurality of electrical lines that are made of the transparent and conductive polymer and insulated by a plurality of electrical insulators that are made of the transparent and non-conductive polymer.

13. The hearing aid as claimed in claim 12, wherein the electrical lines and the electrical insulators are disposed coaxially.

14. The hearing aid as claimed in claim 13, wherein an outer line of the coaxially disposed electrical lines is grounded.

15. The hearing aid as claimed in claim 11, wherein an impedance of the receiver, an impedance of an amplifier output stage of the electronic signal processor connected to the electrical line and a surface area of the electrical line are tailored to one another to maximum a power transmission by the electrical line.

16. A hearing tube for a hearing aid, comprising:
an electrical line that is made of a transparent and conductive polymer and connects a receiver of the hearing aid electrically to an electronic signal processor of the hearing aid disposed in a housing of the hearing aid; and
an electrical insulator that is made of a transparent and non-conductive polymer and insulates the electrical line.

17. The hearing tube as claimed in claim 16, further comprising a plurality of electrical lines that are made of the transparent and conductive polymer and insulated by a plurality of electrical insulators that are made of the transparent and non-conductive polymer

18. The hearing tube as claimed in claim 17, wherein the electrical lines and the electrical insulators are disposed coaxially.

19. The hearing tube as claimed in claim 18, wherein an outer line of the coaxially disposed electrical lines is grounded.

20. The hearing tube as claimed in claim 16, wherein a surface area of the electrical line is tailored to an impedance of the receiver connected thereto and an amplifier output stage of the electronic signal processor connected thereto to maximum a power transmission by the electrical line.
